(19) United States
(12) Patent Application Publication
(10) Pub. No.: US 2026/0070651 A1
(43) Pub. Date: Mar. 12, 2026

(54) SPACER TO COVER A GAP BETWEEN A SIDEWALL AND A MONUMENT WALL, AND AN AIRCRAFT HAVING SUCH SPACER

(71) Applicants: Airbus Operations GmbH, HAMBURG (DE); Airbus Operations SAS, TOULOUSE (FR)

(72) Inventors: Benedikt KIRCHER, HAMBURG (DE); Michael KONECNY, HAMBURG (DE); Nicolas MARCHAND, TOULOUSE (FR)

(21) Appl. No.: 19/317,271

(22) Filed: Sep. 3, 2025

(30) Foreign Application Priority Data
Sep. 11, 2024 (DE) 10 2024 126 119.6

(51) Int. Cl. B64C 1/40; F16B 5/00

(52) U.S. Cl. CPC B64C 1/403; F16B 5/0004

(57) ABSTRACT

A spacer for covering a gap between a sidewall arranged in a longitudinal direction and a monument wall arranged in a transverse direction in an aircraft. The spacer includes an upper mount, and a lower mount. The lower mount restricts a relative movement between the monument and the spacer in the longitudinal direction, and allows a relative movement in the transverse direction.

### CROSS-REFERENCES TO RELATED APPLICATIONS

This application claims the benefit of German Patent Application Number 102024126119.6 filed on Sep. 11, 2024, the entire disclosure of which is incorporated herein by way of reference.

### FIELD OF THE INVENTION

The present disclosure generally relates to a spacer covering a gap between a sidewall and a monument wall in an aircraft, and a corresponding aircraft. Particularly, the present disclosure relates to a spacer that can be mounted to the monument, and an aircraft having a monument, a sidewall and a spacer covering a gap therebetween.

### BACKGROUND OF THE INVENTION

A conventional transition between a sidewall and a monument wall in an aircraft is made by cutting the sidewall or the monument wall to have a small gap between both walls and filling such gap with an elastic filler, such as a rubber band. Usually, a sidewall covers the interior of a fuselage of the aircraft, such as frames and stringers of the fuselage. A sidewall covers one or more frames, and a plurality of sidewalls are installed along the longitudinal direction (flight direction) of the fuselage of the aircraft. The sidewalls are often installed before interior components of the aircraft are brought into the fuselage. Thus, when a monument is installed in an aircraft interior space (i.e., an aircraft cabin) the fuselage is mainly covered by sidewalls irrespective of the installation space of the monument. The monument regularly has one or more monument walls arranged substantially along a transverse direction of the fuselage, i.e. substantially perpendicular to the longitudinal direction and hence substantially perpendicular to the sidewall.

Therefore, the outer end of the monument wall and/or a sidewall is to be cut, so that both walls have matching or corresponding edges. The small space between these concerted edges is then filled with an elastic filler. In case of a monument extending in the longitudinal direction of the aircraft, at least two monument walls and associated sidewalls have to be adapted to one another.

However, such monument installation and adaptation to the sidewall is cumbersome and time-consuming.

### SUMMARY OF THE INVENTION

It is therefore an object of the present disclosure to render installation of monuments adjacent to a sidewall easier.

According to a first aspect to better understand the present disclosure, a spacer for covering a gap between a sidewall arranged in a longitudinal direction and a monument wall arranged in a transverse direction in an aircraft comprises an upper mount, and a lower mount. A sidewall is configured to cover the fuselage of an aircraft, so that it can have the shape of a portion of a cylinder corresponding to the shape of the interior side of the fuselage. The term sidewall shall also be understood to include the ceiling wall of the fuselage. A monument can be a galley, lavatory, a cabinet, a storage compartment, a separating wall or the like and includes at least one monument wall arranged in the transverse direction of the aircraft. The transverse direction is substantially perpendicular to the longitudinal direction of the aircraft. Thus, the monument wall is arranged substantially perpendicular to the sidewall. It is to be understood that “substantially perpendicular” includes an arrangement of the monument wall in a range of 90°+/−20° with respect to the sidewall, e.g., with respect to the longitudinal direction of the aircraft.

The lower mount comprises a monument-fixated holder, a spacer-fixated holder, and coupling means configured to couple the monument-fixated holder and the spacer-fixated holder. The coupling means are further configured to restrict a relative movement between the monument-fixated holder and the spacer-fixated holder in the longitudinal direction, and to allow a relative movement in the transverse direction.

The provision of the monument-fixated holder allows installing the spacer together with the monument. Particularly, the monument-fixated holder can be mounted or fixed to the monument wall. By restricting a relative movement between the monument-fixated holder and the spacer-fixated holder in the longitudinal direction ensures that a gap between the spacer and the monument wall remains the same irrespective of any movement of the spacer and the monument. As a mere example, during flight (or other movement of the aircraft) the fuselage and the monument may experience a relative movement with respect to one another, for example, due to bending of the fuselage, a cabin floor (on which the monument is mounted) or other dynamic actions of the aircraft.

In conventional filler solutions, such relative movement may act on the filler resulting in the filler being detached from the monument wall and/or the sidewall (edge).

In the present disclosure, the spacer is fixed relative to the monument. The spacer can be arranged to either cover the sidewall or be flush with the sidewall, so that any relative movement between the spacer and the sidewall is not visible or does not result in open gaps as may be the case in conventional filler solutions.

In addition, providing the monument-fixated holder allows preparation of the monument wall including such holder(s), installing the monument in the aircraft interior, and then simply mounting the spacer to the monument. An adaptation of the sidewall can be omitted, or the sidewall can simply be cut irrespective of the form of the monument, wherein the resulting (larger) gap can be covered by the spacer. Thus, the installation time and costs can be significantly reduced.

It is to be understood that the monument wall and sidewall can be interchanged by other walls in an aircraft arranged substantially perpendicular to one another. Thus, a spacer as disclosed herein can likewise be provided to cover a gap between any two substantially perpendicularly arranged walls in an aircraft. As a mere example, such a gap may also be present between an overhead luggage compartment and any surrounding wall or even ceiling panel. Likewise, linings and panels in an entrance area of an aircraft are often installed in a substantially perpendicular manner, where a corresponding gap can be closed by the disclosed spacer. Therefore, “monument” and “sidewall” are not to be understood as limiting the present disclosure to walls of particular interior components of the aircraft.

In a variant, the size of the spacer in the longitudinal direction can be larger than that of a conventional filler. As a mere example, a spacer can have a size in the longitudinal direction of more than 3 cm, more than 5 cm, more than 10 cm, more than 20 cm, or even more than 50 cm. The size of the spacer in the longitudinal direction is not restricted by these examples, but may be set by the side edge of the adjacent sidewall (at a longitudinal end of the sidewall) or by a cutting-edge of the sidewall optimized for the sidewall installation (e.g., close to sidewall mounts) and not optimized for the monument.

In a variant, the monument-fixated holder can comprise a groove, wherein the coupling means comprise a sliding block configured to be inserted into and slide along the groove. The groove can be arranged along the transverse direction or in a transverse plane, so that the sliding block is restricted or hindered from a relative movement with respect to the monument wall. When the sliding block slides along the groove, the spacer-fixated holder can perform a relative movement to the monument wall (actually relative to the monument-fixated holder having the groove). Thus, a relative movement between the monument and the sidewall can be (at least partially) compensated by a movement of the spacer relative to the monument.

In a variant, at least the groove can form a circular arc having a center at the upper mount. For instance, the groove can be formed along a circular arc in the monument-fixated holder, or the monument-fixated holder has a shape according to the circular arc. In any case, such form of the groove allows the sliding block to perform a circular movement around the upper mount. Thus, the spacer can swing or oscillate around the upper mount, which facilitates compensation of a relative movement between monument and fuselage (sidewall) while maintaining a constant distance between spacer and monument, which improves visual appearance of the transition from monument to sidewall.

In a variant, the groove can comprise an end stop at each end of the groove which end is configured to stop a movement of the sliding block along the groove. Thus, the sliding block can be prevented from disengaging the groove, and the spacer can be securely mounted to the monument.

In a variant, the coupling means can comprise a first damper configured to absorb vibrations of the spacer in the longitudinal direction. Thus, a relative movement between sidewall and monument and/or spacer and monument can be partially compensated by the damper. It is to be understood that the damping shall not allow a movement of the spacer in the longitudinal direction relative to the monument wall to such an extent that the spacer touches the monument wall. In other words, the coupling means of the lower mount shall restrict a relative movement in the longitudinal direction between the spacer and the monument wall, while the first damper shall only lead to a very small amount of such relative movement.

As a mere example, the first damper may be configured to allow a movement of the spacer relative to the monument wall in the longitudinal direction of less than 20%, less than 10%, less than 5%, or even less than 2% of the distance of an edge of the spacer to the monument wall. This particularly applies for regular or normal flight situations. It is to be understood that in case of intense load changes, for example, high-intensity vibrations in the aircraft, such as during landing, turbulences or other high g-load situations a movement between the edge of the spacer and the monument wall may be larger than 20%, up to 80% or even up to 100% of the distance between edge of the spacer and monument wall, as dampening such high loads may not be possible.

In a variant, the coupling means can comprise a second damper configured to absorb vibrations of the spacer in the transverse direction. Thus, while the coupling means of the lower mount allow a certain freedom of a movement of the spacer in the transverse direction in the region of the lower mount, the second damper shall reduce vibrations, i.e., swinging or oscillating of the spacer in the transverse direction. This reduces noise generated by the spacer.

In another variant, the coupling means can comprise a damping component configured to absorb vibrations of the spacer in the longitudinal direction and the transverse direction. In other words, the above-describe first and second damper are integrated into the single damping component.

As a mere example, the damping component can be an elastic component. For instance, the damping component can be made from an elastic material, such as an elastomer (or rubber), and can have a shape facilitating damping in the longitudinal direction and the transverse direction.

In yet another variant, the coupling means can comprise a third damper or integrated damping component configured to absorb vibrations of the spacer in a direction perpendicular to the longitudinal direction and perpendicular to the transverse direction. As a mere example, the third damper or integrated damping component can be configured to absorb vibrations of the spacer in a substantially vertical direction. In a variant, the lower mount can further comprise a plurality of fixations spaced apart in the transverse direction, an adjustment plate configured to be mounted to one or a subset of the plurality of fixations, and a biasing element coupled to a fixation of the coupling means. These components of the lower mount form a security measure. For instance, the biasing element can be arranged to bias in the transverse direction. Thus, the spacer can still perform a relative movement to the monument wall in the transverse direction, but is limited to a certain movement extend due to the increasing biasing force in either direction along the transverse direction.

As a mere example, since the spacer can face a passenger cabin of the aircraft, a passenger may fumble or fiddle with the spacer including pulling the spacer away from the sidewall, i.e. along the transverse direction. The biasing element (like the end stop of the groove) may limit such pulling on the spacer.

Furthermore, the plurality of fixations spaced apart in the transverse direction allow mounting the adjustment plate at different positions at the monument-fixated holder along the transverse direction. Thus, during installation of the spacer to the monument, the adjustment plate can be mounted to the monument-fixated holder at a location along the transverse direction in an optimal position of the spacer. The biasing element limits the movement of the spacer along the transverse direction relative to the monument wall.

In a variant, the monument-fixated holder can comprise a hook, the spacer-fixated holder can comprise a pyramidal component, and the coupling means can comprise a loop coupled to the pyramidal component and configured to be hooked into the hook. Thus, installation of the spacer to the monument can be achieved in an easy manner, which saves installation time and costs.

In a variant, the spacer can further comprise a gliding component arranged on a surface of the spacer facing a surface of the sidewall. Thus, the spacer can be configured to contact the sidewall via the gliding component, to achieve a flush transition from the spacer to the sidewall. The gliding component allows a relative movement between the sidewall and the monument-mounted spacer. As a mere example, the gliding component can include PTFE (Polytetrafluoroethylene) or the like. The gliding component can further be configured as a cushion damping any relative movement between the sidewall and the spacer in the transverse direction and closing any gap between the sidewall and the spacer due to manufacturing tolerances.

In a variant, the spacer can further comprise a side mount configured to be mounted to a frame bracket and hold the spacer at a position spaced apart from the monument wall. Particularly, in case of a larger spacer extending in the longitudinal direction, an additional mount may become necessary (in addition to the upper and lower mounts) to securely mount the spacer in the interior of the aircraft.

A frame bracket can be a bracket that is attached to a frame of the fuselage of the aircraft. Such frame bracket may be a conventional bracket for installation of a sidewall to the frame.

In a variant, the side mount can comprise a base plate configured to be mounted to the frame bracket, a first hook provided on the basis plate, and a second hook coupled to the spacer and configured to be hooked into the first hook. Such hook coupling can allow a relative movement of the spacer to the frame bracket in the longitudinal direction as well as in a vertical direction, but blocks or hinders a movement of the spacer in the transverse direction. Since the sidewall is regularly also mounted to the frame or the frame bracket, a relative movement between the spacer and the sidewall in the transverse direction is restricted.

According to a second aspect to better understand the present disclosure, an aircraft comprises a sidewall, a monument having a monument wall arranged substantially perpendicular to the sidewall, wherein a side edge of the sidewall is spaced apart from a surface of the monument wall facing the sidewall, and a spacer according to the first aspect or one or more of its variants. The spacer covers a gap between the monument wall and the side edge of the sidewall.

The present disclosure is not restricted to the aspects and variants in the described form and order. Specifically, the description of aspects and variants is not to be understood as a specific limiting grouping of features. It is to be understood that the present disclosure also covers combinations of the aspects and variants. Thus, each variant or optional feature can be combined with any other aspect, variant, optional feature or even combinations thereof.

### BRIEF DESCRIPTION OF THE DRAWINGS

In the following, the present disclosure will further be described with reference to exemplary implementations illustrated in the figures, in which:

FIG. 1 schematically illustrates an aircraft region including a spacer between a monument and a sidewall;

FIGS. 2A-2B schematically illustrate perspective views of an upper mount;

FIG. 3 schematically illustrates a sectional view of a spacer including mounts;

FIG. 4 schematically illustrates a sectional view of a spacer including other mounts;

FIG. 5 schematically illustrates a sectional view of a spacer including yet another mount;

FIG. 6 schematically illustrates a front view and a side view of the mount of FIG. 5;

FIG. 7 illustrates a perspective view of a schematic structure forming a lower mount;

FIG. 8 schematically illustrates a cross-sectional view of the mount of FIG. 7;

FIG. 9 schematically illustrates a view of a lower mount in a longitudinal direction;

FIG. 10 schematically illustrates a view of a lower amount in a transverse direction;

FIG. 11 schematically illustrates a front view of another lower mount;

FIGS. 12 to 14 schematically illustrate different perspective views of yet another lower mount; and

FIG. 15 schematically illustrates an aircraft comprising a spacer between a monument and a sidewall.

### DETAILED DESCRIPTION OF THE PREFERRED EMBODIMENTS

In the following description, for purposes of explanation and not limitation, specific details are set forth in order to provide a thorough understanding of the present disclosure. It will be apparent to one skilled in the art that the present disclosure may be practiced in other implementations that depart from these specific details.

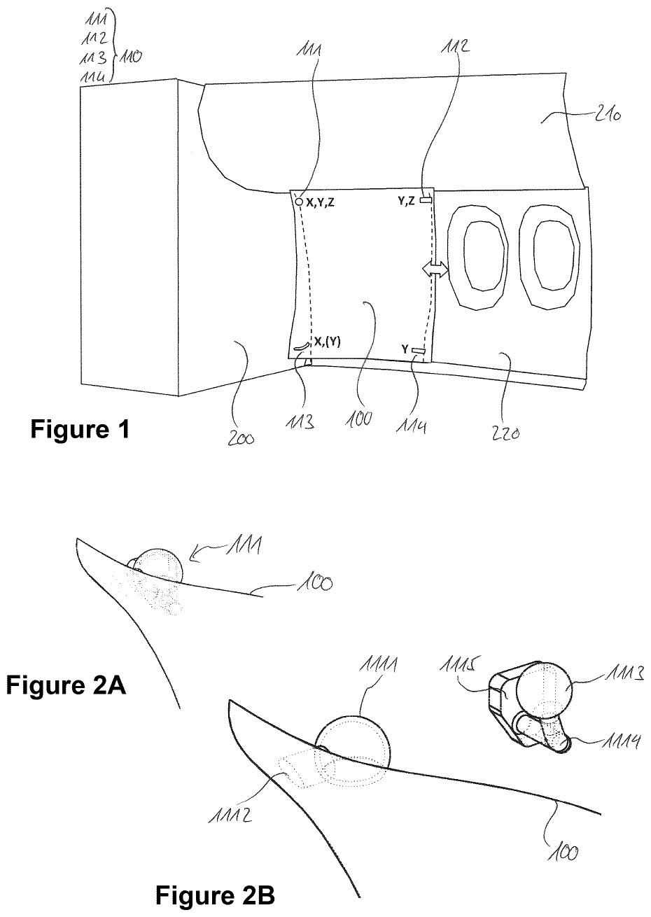

FIG. 1 schematically illustrates an aircraft region including a spacer 100 between a monument 200 and a sidewall 220. The sidewall 220 is arranged along a longitudinal direction of the aircraft and covers the fuselage of the aircraft. For instance, the sidewall 220 may cover an area comprising two windows of the aircraft. Furthermore, a ceiling panel or overhead stowage compartment 210 can be arranged above the sidewall 220.

The spacer 100 is mounted in the aircraft region by two or more mounts 110. FIG. 1 exemplarily illustrates four mounts 111 to 114 at respective corners of the spacer 100. For instance, the spacer 100 may be equipped with an upper mount 111 and a lower mount 113, which will be explained in the following.

It is to be noted that the spacer 100 in FIG. 1 is quite a long in the longitudinal direction. Such large spacer 100 increases visibleness of the elements of the aircraft region in the drawing. On the other hand, a spacer 100 could actually have such size in the longitudinal direction, if a large gap is to be closed.

FIG. 2A-2B schematically illustrate perspective views of an upper mount 111. FIG. 2A is the upper mount 111 when the spacer is installed in the aircraft region, while FIG. 2B shows the upper mount 111 in a detached condition. Specifically, the upper mount 111 can include a monument-fixated holder 1115 that is mounted to or integrated into the monument wall 200 (i.e., a wall of the monument) arranged substantially perpendicular to the sidewall 220. The upper mount 111 further includes a spacer-fixated holder 1112.

Coupling means are provided that couple the monument-fixated holder 1115 to the spacer-fixated holder 1112. For instance, on the spacer side can be a joint socket 1111, while on the monument side can be a joint ball 1113. The joint ball 1113 can be received in the joint socket 1111, by imposing the socket 1111 over the joint ball 1113. The coupling means can further include a bar and/or damper 1114 connecting the joint ball 1113 to the monument-fixated holder 1115. On the one hand, this allows positioning the joint ball 1113 at the respective distance from the monument-fixated holder 1115, and, on the other hand, it allows dampening vibrations or similar relative movement between the spacer 100 and the monument wall 200.

Employing a joint socket and joint ball 1111, 1113 at the upper mount 111 provides several freedoms of movement for the spacer 100 relative to the monument 200. Nevertheless, a relative movement between spacer 100 and monument 200 is restricted in the longitudinal direction, the transverse direction as well as a vertical direction (the latter being perpendicular to the longitudinal and the transverse direction).

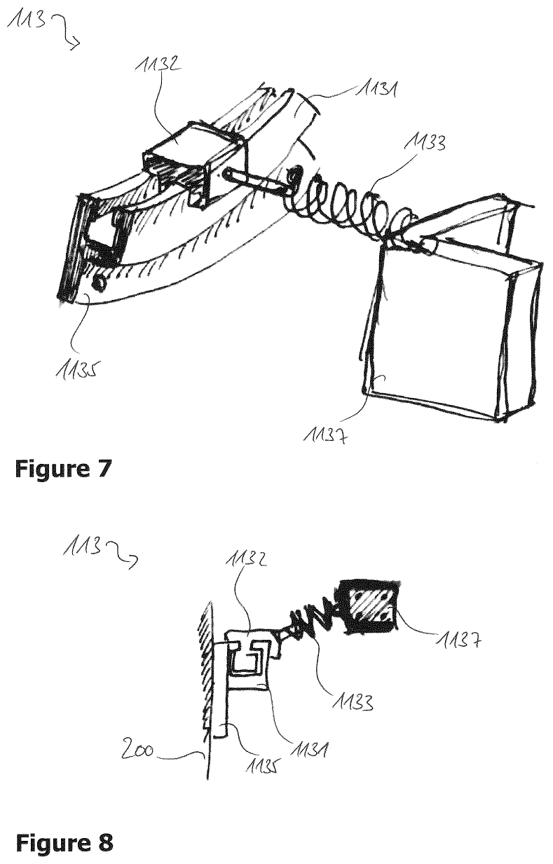

FIGS. 7 and 8 schematically illustrate a perspective view and a cross-sectional view of a schematic structure forming a lower mount 113. It is to be understood that the elements of the lower mount 113 in these drawings are given for schematic and explanatory reasons and may not reflect the actual implementation.

The lower mount 113 comprises a monument-fixated holder 1131, 1135, a spacer-fixated holder 1137, and coupling means configured to couple the two holders with one another. The coupling means are further configured to restrict a relative movement between the monument-fixated holder 1131, 1135 and the spacer-fixated holder 1137 in the longitudinal direction of the aircraft and to allow a relative movement in the transverse direction.

In the illustrated variant, the monument-fixated holder 1131 comprises a groove. In FIGS. 7 and 8 the opening of the groove is on the top side, which is only one example. The opening of the groove can likewise be on a lateral side or the bottom side of the holder 1131. The coupling means can comprise a sliding block 1132 configured to be inserted into the groove and further configured to slide along the groove. Thus, the spacer-fixated holder 1137 is capable of moving in the transverse direction, while a movement in the longitudinal direction is blocked.

Depending on the shape of the groove and sliding block 1132, a relative movement of the sliding block 1132 (and hence of the spacer-fixated holder 1137) in a vertical direction is also restricted. As a mere example and as illustrated in FIG. 7, the opening of the groove is smaller (in the longitudinal direction) than the inner space of the groove. Likewise, the sliding block 1132 can have a wider head at its bottom attached to the remainder of the sliding block by a narrow middle section, so that the sliding block 1132 cannot be taken out of the groove through the groove opening (see FIG. 8).

The groove of the monument-fixated holder 1131 or the entire monument-fixated holder 1131, 1135 can form a circular arch. This allows movement of the spacer 100 along such arc of the lower mount 113. As a mere example, a center of the circular arc can be at the upper mount 111, for example, at a center of the joint ball 1113. Thus, the spacer 100 is mounted to the monument 200, but can swing around the upper mount 111 guided by the groove in the lower mount 113. A gap between the spacer and the monument wall 200 can be kept constant due to the restriction of the relative movement in the longitudinal direction between spacer 100 and monument wall 200. In addition, in case of relative movements between the sidewall 220 and the monument 200, the spacer 100 can still cover a gap between the sidewall 220 and the monument 200.

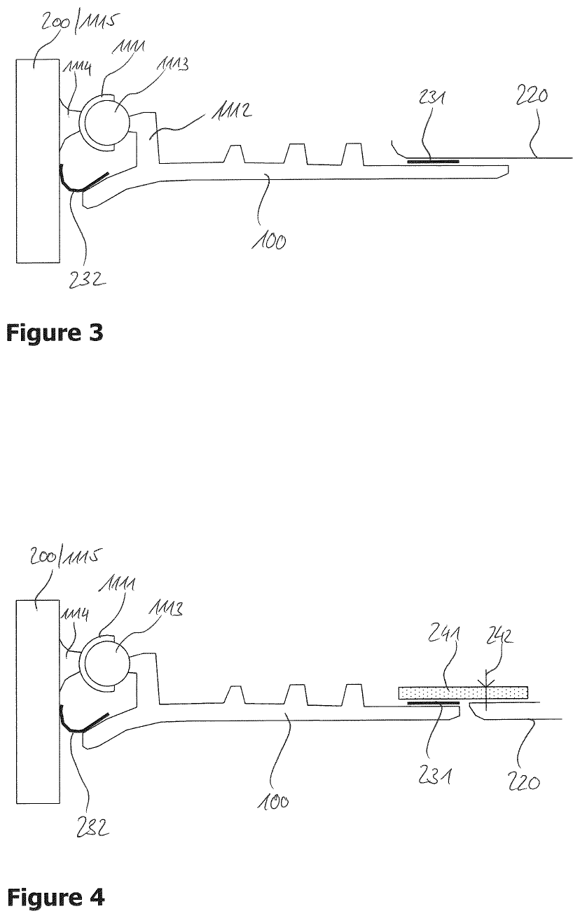

With reference to FIG. 3 schematically illustrating a sectional view of a spacer 100 including upper mount 111, the relationship between monument 200, spacer 100 and sidewall 220 are explained in more detail. Specifically, the ball joint 1111, 1113 (consisting of joint ball 1113 and joint socket 1111) can be mounted to the monument wall 200. The bar or damper 1114 as well as the spacer-fixated holder 1112 sets a distance between the monument wall 200 and a side edge of the spacer 100 (a side edge to the left in FIG. 3). The gap between the side edge of the spacer 100 and a surface of the monument wall 200 will be constant due to the restriction of the movement of the spacer 100 relative to the monument wall 200 in the longitudinal direction (left-right direction in FIG. 3).

This is also noted in FIG. 1 specifying the directions of movement that are preferably restricted by the respective mount 110. For instance, at the upper mount 111 the spacer 100 is restricted in its movement in the longitudinal direction (X), the transverse direction (Y), and the vertical direction (Z). Nevertheless, a rotational movement of the spacer 100 around the joint ball 1113 can be possible. The lower mount 113 restricts the movement of the spacer 100 in the longitudinal direction (X). A movement in the transverse direction (Y) may be possible, but could be dampened or significantly restricted as will be explained in more detail below, so that a movement restriction in the transverse direction is only specified in parentheses.

Referring back to FIG. 3, a gap cover 232 can be provided between the side edge of the spacer 100 and the surface of the monument wall 200. As a mere example, the gap cover 232 can be fixed/attached to the spacer 100 close to the side edge. For instance, the gap cover 232 can be of an elastic material, such as an elastomer or rubber.

Since the spacer 100 is mounted to the monument 200, the installation of the spacer 100 can be independent from the installation of the sidewall 220 in the aircraft as well as from the location of a side edge of the sidewall 220. As can be derived from the schematic drawing of FIG. 3, the gap between a side edge of the sidewall 220 and a surface of the monument wall 200 can be rather wide and is covered by the spacer 100. For instance, the sidewall 220 may be unaltered and regularly ends at the position illustrated in FIG. 3. While in conventional installations, another sidewall would be installed and cut with respect to the position of the monument wall 200, the solution of the present disclosure simplifies such installation.

The monument-mounted spacer 100 can be provided any time before or after installation of the monument 200 in the aircraft and can have a size sufficient to cover the gap between the monument 200 and the sidewall 220. As a mere example, the spacer 100 can be dimensioned to overlap a side region or at least the side edge of the sidewall 220. Since a relative movement between the monument 200 and the sidewall 220 is possible, and since the spacer 100 is mounted to the monument 200, a relative movement between the free end of the spacer 100 and the side region of the sidewall 220 will occur. In the overlapping region, a gliding component 231 may be arranged. For instance, the gliding component 231 can be provided on a surface of the spacer 100 facing a surface of the sidewall 220. Such gliding component 231, which may be made from or include PTFE, protects the sidewall 220 and facilitates the relative movement between the spacer 100 and the sidewall 220. Moreover, the gliding component 231 may also be elastic in the transverse direction, such as a cushion, in order to close the overlapping space between the spacer 100 and the sidewall 220.

FIG. 4 schematically illustrates a sectional view of a spacer 100 including other mounts. Some components are the same as those illustrated in FIG. 3 and are provided with the same reference numerals. A repeated description of the same components is omitted for sake of brevity since it would be repetitious.

Instead of overlapping the sidewall 220, the spacer 100 can be dimensioned to have a side edge in front of the side edge of the sidewall 220. Thus, the interior surfaces of the spacer 100 and the sidewall 220 are flush. In order to avoid an open gap between spacer 100 and sidewall 220, an interface component 241 can be mounted to the back side (exterior facing side) of the sidewall 220. The spacer 100 can then be configured to overlap with this interface component 241, and a gliding component 231 may be provided either on the spacer 100 or the interface component 241.

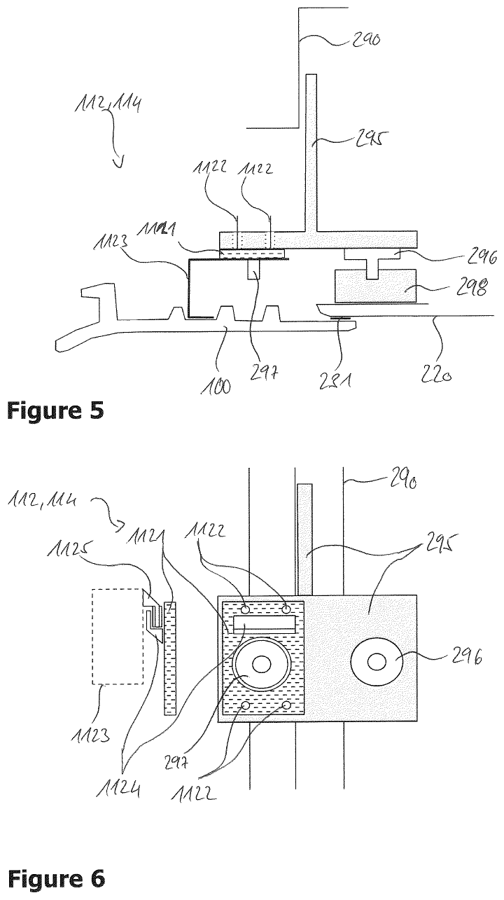

FIGS. 5 and 6 schematically illustrate a sectional view of a spacer 100 including an additional mount, and front and side views of the additional mount, respectively.

For instance, the additional mount can be a side mount 112, 114 (FIG. 1) configured to be mounted to a frame bracket 295 and to hold the spacer 100 at a position spaced apart from the monument wall 200 (a position closer to the sidewall 220 than the monument 200). For instance, in case the size of the spacer 100 in the longitudinal direction increases, for example, due to a side edge of a sidewall 220 being located further away from the monument wall 200, a spacer 100 solely mounted by the upper and lower mounts 111, 113 may not be securely held the monument. Likewise, the spacer 100 may perform larger relative movement to the sidewall 220 due to the long lever arm one by such large spacer 100. Thus, an additional side mount 112, 114 facilitates a stable fixation of the spacer 100.

The frame bracket 295 can be a regular bracket mounted to a frame 290 of the aircraft, which is regularly used to mount other interior components, such as the sidewall 220. For instance, a shock mount 296 (a mount including a shock absorber or damper) can be provided on an interior side of the frame bracket 295. An intermediate element 298 can also be provided, for example, to adjust a distance between the outer side of the sidewall 220 and the frame bracket 295 (e.g., due to manufacturing tolerances or the like). As illustrated in FIGS. 5 and 6, a pair of such shock mounts may be provided, for example, to install two adjacent sidewall 220 along the longitudinal direction of the aircraft.

Instead of a second sidewall 220, the associated side of the frame bracket 295 can be employed as a side mount 112, 114 for the spacer 100. While the shock mount 297 on this side of the frame bracket 295 could be used to mount the spacer 100, additionally or alternatively, the side mount 112, 114 can comprise a base plate 1121 configured to be mounted to the frame bracket 295. The base plate 1121 can be mounted to the frame bracket 295, either employing the shock mount 297 or by fasteners 1122.

In addition, the side mount 112, 114 can further comprise a first hook 1124 provided on the base plate 1121, and a second hook 1125 coupled to the spacer 100. The first and second hooks 1124, 1125 can be hooked into one another, for example by hanging the second hook 1125 into the first hook 1124 from above the first hook 1124. The first and second hooks 1124, 1125 can be arranged in a longitudinal direction of the aircraft, which provides a freedom of movement of the spacer 100 at the side mount 112, 114 in the longitudinal direction (Y).

The spacer 100 can be coupled to the second hook 1125 is directly or via an intermediate element 1123. Such intermediate element 1123 may be employed, in order to adjust a distance between the spacer 100 and the front face of the frame bracket 295. Thus, different intermediate elements 1123 or an adjustable intermediate element 1123 can be provided. This further allows bringing the spacer 100 in front of the sidewall 220, in order to overlap the same and as illustrated in FIG. 5. Alternatively, the spacer 100 could also be arranged next to the side edge of the sidewall 220 to have a flush surface with the sidewall 220 (as in FIG. 4, but without the interface component 241).

A non-illustrated example may include a structure in intermediate element 1123 allowing a dedicated freedom of movement in the transverse direction (up-down direction in FIG. 5). As a mere example, such freedom of movement can be achieved by a similar hook arrangement as first and second hooks 1124, 1125 arranged in the transverse direction.

Returning to the lower mount 113 of FIGS. 7 and 8, the coupling means of the lower mount 113 can comprise a first damper 1133 configured to absorb vibrations of the spacer 100 in the longitudinal direction and/or in the transverse direction. FIGS. 7 and 8 schematically illustrate such first damper 1133 as a spring. It is to be understood that the first damper 1133 can be implemented in a different manner, such as an elastic material (e.g., an elastomer or rubber). It is further to be understood that the first damper 1133 may damp vibrations and thereby allow a certain degree of freedom of movement. This, however, is a much smaller movement than compared to the movement of the sliding block 1132 in the groove of the monument-fixated holder 1131.

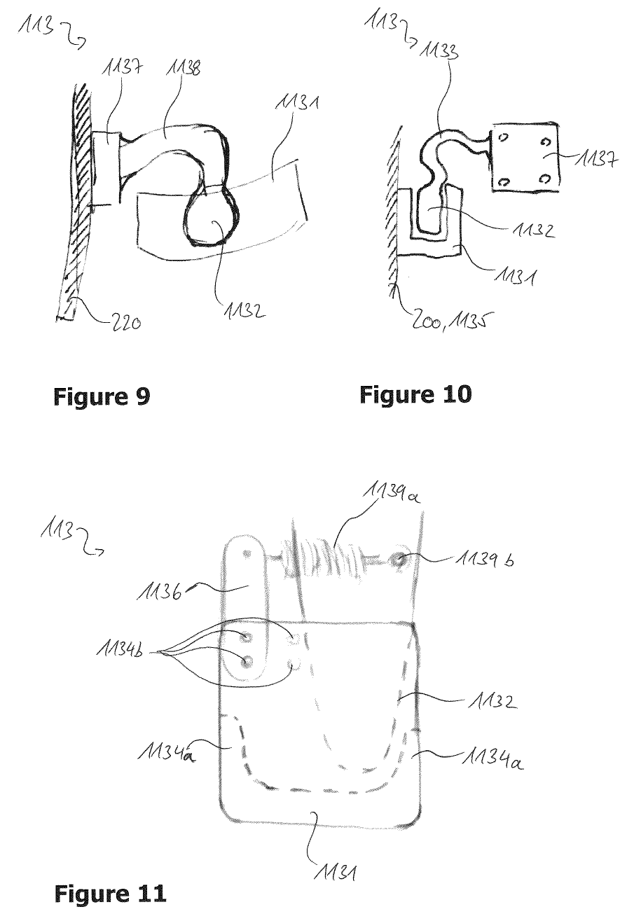

FIGS. 9 and 10 schematically illustrate a view of a lower mount 113 in a longitudinal direction and in a transverse direction, respectively. Here, instead of a schematic spring the coupling means is illustrated as a bent holding structure. Due to the bent shape a first damper 1133 can be implemented vibrations in the longitudinal direction (cf. FIG. 10). Likewise, the holding structure can also be bent in the transverse direction (cf. FIG. 10), so that the coupling means comprise a second damper 1138 configured to absorb vibrations of the spacer 100 in the transverse direction. FIG. 11 schematically illustrates a front view of another exemplary implementation of a lower mount 113. Specifically, the groove of the monument-fixated holder 1131 comprises an end stop 1134a at each and of the groove that is configured to stop a movement of the sliding block 1132 along the groove. This prevents the sliding block 1132 from disengaging the groove, i.e. from disengaging the monument-fixated holder 1131. Thus, the spacer 100 may not become loose at the lower end.

A further exemplary in detail of the lower mount 113 is also illustrated in FIG. 11. Specifically, the sliding block 1132 can be limited in its freedom of movement in the transverse direction. This can be achieved by a plurality of fixations 1134b at the lower mount 113, such as the monument-fixated holder 1131 or a base plate 1135 of the lower mount 113 (FIGS. 7 and 8). An adjustment plate 1136 may include recesses or openings to receive some of the fixations 1134b. As a mere example, the plurality of fixations 1134b can be arranged along the transverse direction, such as at predetermined intervals. The adjustment plate 1136 can then be arranged at these predetermined intervals. This provides for the first limitation on the location of the sliding block 1132 in the groove.

A biasing element 1139a can be coupled to a fixation of the coupling means of the lower mount 113, particularly a fixation 1139b at the sliding block 1132. The biasing element 1139a provides a second limitation to the sliding block 1132, particularly a limitation to the movement in the groove due to the biasing force acting on the sliding block 1132.

Thus, the example of FIG. 11 still provides a freedom of movement in the transverse direction for the spacer 100. However, the spacer can be secured at the lower mount 113, and particularly can be protected from being disengaged or detached from the lower mount 113. As a mere example, a passenger may pull at a lower edge of the spacer 100. Without the end stop 1134a and/or without the adjustment plate 1136, fixations 1134b and biasing element 1139a, the passenger may detach the spacer 100 from the lower mount 113.

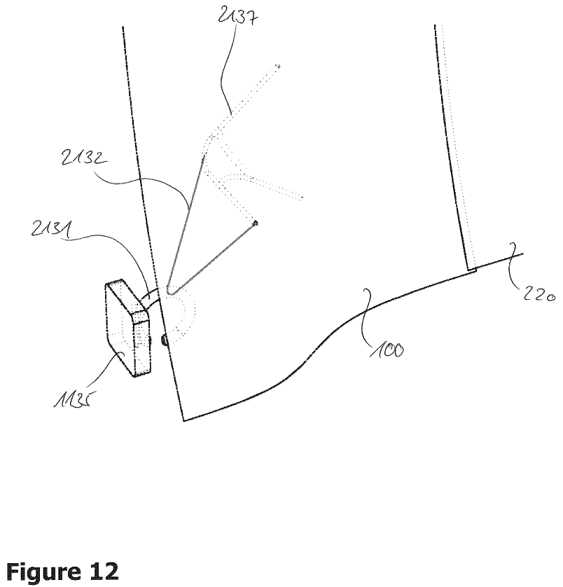

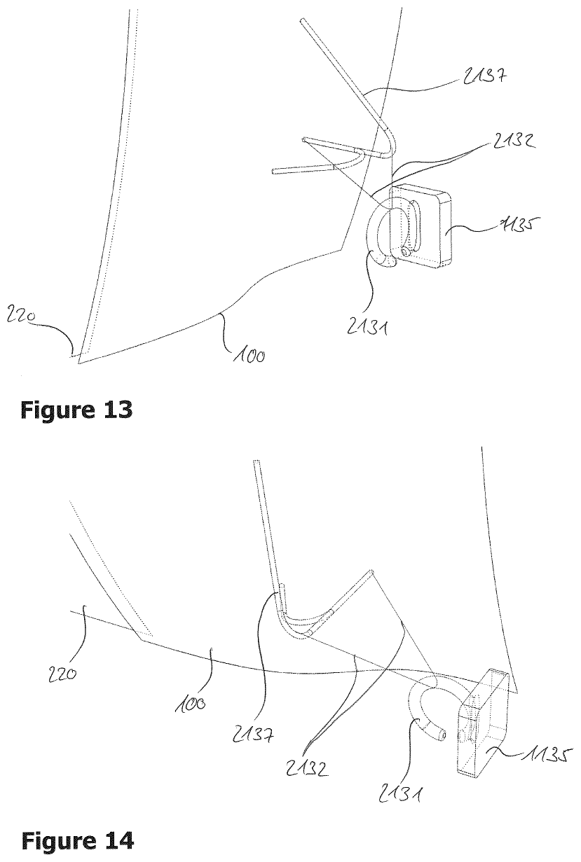

FIGS. 12 to 14 schematically illustrate different perspective views of yet another lower mount 113. Elements of same function as in the embodiments described above are provided with the same reference numerals, and their repetitious description will be omitted for sake of brevity.

The monument-fixated holder comprises a hook 2131, and the spacer-fixated a holder comprises a pyramidal component 2137. The coupling means of the lower mount 113 comprises a loop 2132 coupled to the pyramidal component 2137. The loop 2132 is configured to be hooked into the hook 2131. This allows a very easy and fast installation of the spacer 100, since only the loop 2132 has to be hooked into a monument-fixated component 2131.

The loop 2132 allows a freedom of movement of the spacer 100 relative to the monument wall 200 at least in the longitudinal and transverse directions. For instance, by mounting the spacer 100 via upper mount 111 and (upper) side mount 112, the spacer 100 is relatively fixed in the longitudinal direction (X), also at the lower mount 113. Thus, hooking the loop 2132 into the hook 2131 in such a manner that the loop 2132 is under tension (particularly in the longitudinal direction and at least partially in the transverse direction and/or vertical direction) allows fixation of the spacer 100 in the longitudinal direction while, at the same time, providing a dampening of vibrations of the spacer 100 relative to the monument wall 200.

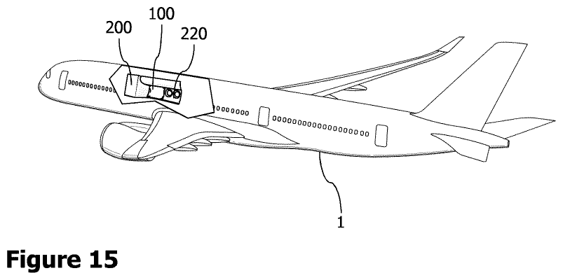

FIG. 15 schematically illustrates an aircraft 1 comprising a spacer 100 between a monument 200 and a sidewall 220.

It is believed that the advantages of the technique presented herein will be fully understood from the foregoing description, and it will be apparent that various changes may be made in the form, constructions and arrangement of the exemplary aspects thereof without departing from the scope of the disclosure or without sacrificing all of its advantageous effects. Because the technique presented herein can be varied in many ways, it will be recognized that the disclosure should be limited only by the scope of the claims that follow.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A spacer for covering a gap between a sidewall arranged in a longitudinal direction and a monument wall arranged in a transverse direction in an aircraft, the spacer comprising:
an upper mount; and
a lower mount,
wherein the lower mount comprises:
a monument-fixated holder,
a spacer-fixated holder, and
coupling means configured to couple the monument-fixated holder and the spacer-fixated holder, to restrict a relative movement between the monument-fixated holder and the spacer-fixated holder in the longitudinal direction, and to allow a relative movement in the transverse direction.

2. The spacer of claim 1,
wherein the monument-fixated holder comprises a groove,
wherein the coupling means comprise a sliding block configured to be inserted into and slide along the groove, and
wherein at least the groove forms a circular arc having a center at the upper mount.

3. The spacer of claim 2, wherein the groove comprises an end stop at each end of the groove that is configured to stop a movement of the sliding block along the groove.

4. The spacer of claim 1, wherein the coupling means comprise a first damper configured to absorb vibrations of the spacer in the longitudinal direction.

5. The spacer of claim 1, wherein the coupling means comprise a second damper configured to absorb vibrations of the spacer in the transverse direction.

6. The spacer of claim 1,
wherein the coupling means comprise a first damper configured to absorb vibrations of the spacer in the longitudinal direction, and
wherein the coupling means comprise a second damper configured to absorb vibrations of the spacer in the transverse direction.

7. The spacer of claim 1, wherein the coupling means comprise a damping component configured to absorb vibrations of the spacer in the longitudinal direction and the transverse direction, wherein the damping component is an elastic component.

8. The spacer of claim 1, wherein the lower mount further comprises:
a plurality of fixations spaced apart in the transverse direction,
an adjustment plate configured to be mounted to one or a subset of the plurality of fixations, and
a biasing element coupled to a fixation of the coupling means.

9. The spacer of claim 1,
wherein the monument-fixated holder comprises a hook,
the spacer-fixated holder comprises a pyramidal component, and
the coupling means comprise a loop coupled to the pyramidal component and configured to be hooked into the hook.

10. The spacer of claim 1, further comprising a gliding component arranged on a surface of the spacer facing a surface of the sidewall.

11. The spacer of claim 1, further comprising a side mount configured to be mounted to a frame bracket and to hold the spacer at a position spaced apart from the monument wall.

12. The spacer of claim 11, wherein the side mount comprises:
a base plate configured to be mounted to the frame bracket,
a first hook provided on the base plate, and
a second hook coupled to the spacer and configured to be hooked into the first hook.

13. An aircraft comprising:
a sidewall;
a monument having a monument wall arranged substantially perpendicular to the sidewall, wherein a side edge of the sidewall is spaced apart from a surface of the monument wall facing the sidewall; and
a spacer according to claim 1, and covering a gap between the monument wall and the side edge of the sidewall.
